(19) United States
(12) Patent Application Publication
(10) Pub. No.: US 2004/0154985 A1
(43) Pub. Date: Aug. 12, 2004

(54) Method and apparatus for producing particles via supercritical fluid processing

(75) Inventors: Boris Y. Shekunov, Aurora, OH (US); Pratibhash Chattopadhyay, North Royalton, OH (US); Jeffrey S. Seitzinger, Broadview Heights, OH (US)

Correspondence Address: RANKIN, HILL, PORTER & CLARK, LLP, 925 EUCLID AVENUE, SUITE 700, CLEVELAND, OH, 44115-1405, US

(73) Assignee: Ferro Corporation, Cleveland, OH

(21) Appl. No.: 10/691,113

(22) Filed: Oct. 22, 2003

Related U.S. Application Data
(60) Provisional application No. 60/445,954, filed on Feb. 7, 2003.

(51) Int. Cl. B01D 11/04

(52) U.S. Cl. 210/634; 366/348; 239/9; 264/12

(57) ABSTRACT

An apparatus and method for producing particles using supercritical fluid with enhanced mixing. The process includes a vessel having an inner surface defining a chamber. A high-speed shear or turbulent mixer is incorporated inside the vessel in order to create a region of enhanced mixing (mixing zone). A supercritical fluid pump communicates with the first inlet, and supplies supercritical fluid into the mixing zone through the first inlet. A solution pump communicates with the second inlet, and supplies solution into the mixing zone through the second inlet. A mixer assembly includes a motor drive and a rotor. The rotor is in the mixing zone and can mix the solution and the supercritical fluid. Particles are produced when the solution and the supercritical fluid are pumped into the mixing zone while the rotor is mixing. The design of the mixer and the direction of the flow of materials into the chamber creates a plug flow in the mixing zone. The plug flow allows the particles to be removed from the mixing zone as soon as they are precipitated. Because of the high intensity homogeneous mixing and plug flow configuration, the particle uniformity is enhanced and production of composite particles facilitated.

### BACKGROUND OF THE INVENTION

1. Field of Invention

The present invention relates generally to a method and apparatus for producing small particles via supercritical fluid processing. More particularly, the invention relates to a method and apparatus for dispensing a solution into a flowing stream of supercritical fluid under mixing conditions to precipitate uniformly small particles of solute.

2. Description of Related Art

Supercritical fluids have been used in particle processing to separate solvent-soluble materials from the solvents in which they have been dissolved. Conventional supercritical fluid processes rely on the large diffusion coefficient and the low viscosity of the supercritical fluids, relative to sub-critical solutions, to separate the solvent-soluble materials from the solvent. These properties enable the supercritical fluid to separate particulate products, organic solvents or impurities from each other based on the relative degree of solubility, or insolubility, in the supercritical fluid.

In a process known as Precipitation with Compressed Anti-solvents (PCA), a liquid solution is injected into a compressed gas to precipitate solids. The injection of the liquid solution mixes the material with the compressed gas resulting in fast precipitation. When a supercritical fluid is used rather than a compressed gas on a larger production scale, the process is sometimes referred to as an Aerosol Spray Extraction System (ASES). Capillary nozzles are typically used with PCA or ASES. Sometimes the nozzles are used in combination with ultrasonic dispersing devices.

In another related process, known as Solvent Enhanced Dispersion with Supercritical fluid (SEDS), a twin-fluid mixing nozzle is used. The nozzle co-introduces both a supercritical fluid anti-solvent and a liquid solution feed. The turbulent mixing between the solution and supercritical fluid streams leads to more intensive mixing relative to the PCA and ASES processes. The nozzle then supplies the mixture to a precipitation vessel.

Supercritical fluid particle production processes rely on both the diffusion and mixing rates of the reactants or constituents, which includes the material to be particulated, the solvent, and the supercritical fluid. Because the precipitation rate is strongly influenced by the mixing rates, the precipitation rate can be enhanced by increasing the intensity of mixing between the reactants, or by decreasing the mixing time. Decreasing the nozzle opening size, or passing the flow through a packed bed can thus enhance the precipitation rate. But, decreasing the opening size or passing the flow through a packed bed restricts flow and increases the risk of blockage by particle accumulation. Accordingly, the particle production rate can be hindered by the physical attributes of such a system.

The above-described supercritical fluid processes also suffer from other undesirable limitations. For example, the above-described techniques are not capable of mixing the supercritical fluid with the liquid feed to a sufficiently uniform degree on a macro-scale, thus posing substantial scale up problems. As used herein, “macro-scale” is a process on a dimensional scale comparable to commercial or industrial sized precipitation vessels. For turbulent and convective mixing, large-scale mass-transfer coefficients are more important than diffusion rates. For example, the turbulent diffusivity in CO₂ can be in the order 10³ to 10⁵ times greater than the molecular diffusion coefficient. Thus, nozzles are only capable of sufficiently intensive mixing on a scale comparable to the diameter of a nozzle orifice (typically between 50 micrometers or microns (μm) and 2000 μm). However, such short scale of mixing may not be sufficient for large flow rates during industrial and commercial production.

Further, localized nozzle mixing often results in large particle concentrations near the nozzle orifice. Such concentrations lead to undesired particle agglomeration by formation of bridges between nucleated particles. Accordingly, it is difficult to create very small particles due to the agglomeration and nozzle clogging.

Mixing near or in the nozzles results in the macro-mixing occurring within the precipitation vessel. In such systems, the mixing is facilitated by a combination of low-energy re-circulation or convection flows at low Reynolds numbers (Re<500). Such a mixing regime and system is generally not sufficient to remove solvents with high boiling points (for example, water, toluene, DMSO, DMF and other solvents having boiling points above 373 Kelvin in the standard state).

Further, nozzle injection results in undesirable mixing between the fresh feed and depleted solvent or fluid within the precipitation vessel. This mixing leads to a decrease in the level of supersaturation of the newly introduced solvent. As expected, reducing the supersaturation level reduces product yield, reduces the precipitation rate, and contributes to undesirable growth of particles obtained during the process.

Re-circulation caused by the nozzle flow also leads to interaction between formed (old) particles and precipitating (new) particles, which increases particle agglomeration. The interaction occurs because there is no spatial separation between the nozzle mixing zone and precipitation zone in the vessel.

A particular disadvantage of nozzle mixing is periodic nozzle blockages. The blockages are caused by particle precipitation inside the nozzle. This is especially problematic when using concentrated feed solutions. The blockages cause undesirable process conditions, such as pulsating nozzle flow rates and nozzle overpressure. Pulsating nozzle flow rates and nozzle overpressure can result in process failure as well as non-uniform and inconsistent particulate product.

Heterogeneous flow in the nozzle and an inconsistent mixing regime within the precipitation vessel can make scale-up of the precipitation process problematic. In view of the limitations of the prior art SAS precipitation methods, it would be advantageous to have a technique which enhances the supercritical fluid and solution feed mixing in precipitation vessel or vessel by means of intensive macro-scale mixing alone, or in combination with, a plug reaction flow. Enhanced mixing may result in a homogeneous precipitation regime, and therefore a more consistent production of particulate materials for industrial applications.

### BRIEF SUMMARY OF THE INVENTION

The present invention provides a method of producing particles using an enhanced mixing technique to create particles having a desired morphology and/or size. The method allows for greater control over the properties and uniformity of the particles than is achievable using conventional processes.

The present invention also provides an apparatus for implementing the method according to the invention. The apparatus includes a vessel having a chamber defined by an inner surface and a rotor disposed within the chamber. The region of space between the rotor and the inner surface of the vessel comprises a mixing zone. Mixing intensity is a function of the width of the region between the rotor and the inner surface of the vessel, the topography of the rotor surface and by rotation speed. A solution is dispensed into the mixing zone and in some cases directly into contact with the rotor surface. The solution includes a solvent that is soluble in a supercritical fluid, and a solute dissolved in the solvent. A supercritical fluid flows through the mixing zone as the solution is being dispensed therein. The rotating rotor mixes and agitates the solution and the supercritical fluid into intimate contact with each other. The contact causes the solute to precipitate out from the supercritical fluid/solvent mixture as small particles. The particles are subsequently moved out of the mixing zone and collected downstream.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a schematic diagram of a first embodiment of an apparatus for use in accordance with the method of the invention.

FIG. 2 is a schematic diagram of a second embodiment of an apparatus for use in accordance with the method of the invention.

FIG. 3 is a block diagram of the method according to the invention.

FIGS. 4(a)-(g) are schematic diagrams of rotors suitable for use with the invention.

FIGS. 5(a)-(c) are scanning electron micrographs (SEM) of particles obtained in accordance with the method of the invention.

FIGS. 6(a)-(c) are SEM's of particles obtained in accordance with the method of the invention.

FIG. 7 is a graph showing particle size as a function of rotation speed.

FIG. 8 is a SEM of particles obtained using a standard PCA process for purposes of comparison.

FIGS. 9(a) and (b) are comparative SEM's of particles precipitated under intense mixing conditions according to the invention and under conventional mixing conditions, respectively.

### DETAILED DESCRIPTION OF THE INVENTION

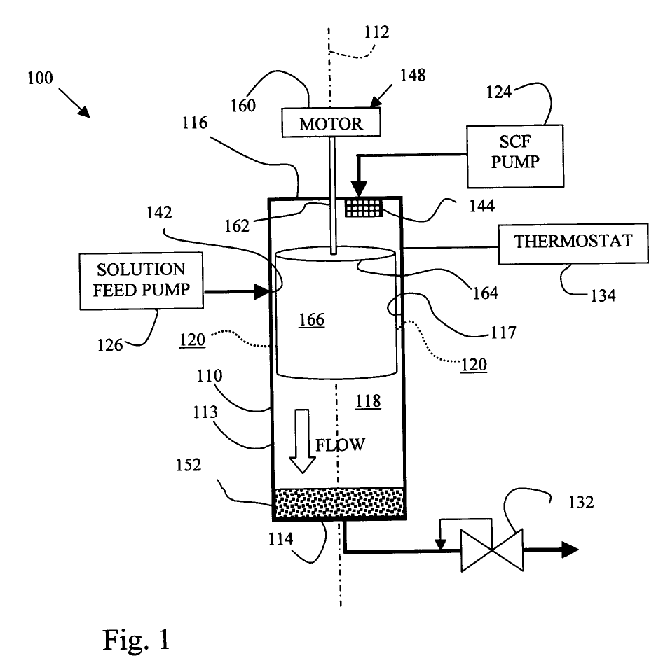

FIG. 1 shows a schematic diagram of a first embodiment of an apparatus 100 for use in implementing the method of the invention. The apparatus 100 comprises a vessel 110, which is preferably cylindrical, having a central axis 112, a sidewall 113, and first and second ends 114, 116 that are spaced axially apart from each other. Preferably, the central axis 112 is oriented vertically such that the first end 114 is below the second end 116. That is, the second end 116 is UP and the first end 114 is DOWN when moving along the central axis 112. In a preferred embodiment, the vessel 110 is about 50 cm long and about 32 mm in diameter, but other sizes can be used. The vessel 110 has an inner surface 117 that defines a chamber 118. A portion of the chamber 118, which is preferably proximal to the second end 116, comprises a mixing zone 120.

The apparatus 100 further comprises a supercritical fluid pump 124 and a solution feed pump 126, which are in fluid communication with vessel chamber 118. A backpressure regulator 132 is also in fluid communication with the vessel chamber 118, preferably proximal to the first end 114. A thermostat 134 controls heating elements (not shown), which are disposed around the vessel 110. Disposed within the chamber 118 are a solution inlet 142 (sometimes also referred to as a solution port or opening), a supercritical fluid inlet 144, a mixer assembly 148, and a filter 152. Because the apparatus 100 shown in FIG. 1 includes only one solution inlet port or opening 142, it is sometimes referred to herein as a “single stream” apparatus.

The supercritical fluid pump 124 is preferably a P-200 high-pressure reciprocating pump commercially available from Thar Technologies, Inc. (Pittsburgh, Pa.). Suitable alternative pumps include diaphragm pumps and air-actuated pumps that provide a continuous flow of supercritical fluid. Preferably, the supercritical fluid pump 124 can be supplemented with a surge tank and metering valve (not shown) so as to produce a pulse-free flow through the apparatus 100. The supercritical fluid pump 124 is in fluid communication with the supercritical fluid inlet 144, and thereby supplies supercritical fluid into the chamber 118. The fluid inlet 144 optionally includes a frit to break the supercritical fluid flow into a plurality of small streams. The supercritical fluid flows from the fluid inlet 144 and into the mixing zone 120.

The solution pump 126 is preferably a high-pressure liquid-chromatography (HPLC) reciprocating pump such as the model PU-2080, which is commercially available from Jasco Inc. (Easton, Md.). Suitable alternative pumps include other reciprocating pumps, diaphragm pumps and syringe type pumps, such as the 1000D or 260D pumps, which are commercially available from Isco Inc. (Lincoln, Nebr.). The solution pump 126 is in fluid communication with the liquid inlet 142, and thereby supplies the solution into the chamber 118. The liquid inlet 142 is preferably a capillary-type tube, or a tube having non-circular cross-section, for example, a slit, and preferably extends through the sidewall 113 and is oriented such that solution exiting the liquid inlet 142 is dispensed directly into the mixing zone 120. Optionally, a head or end of the liquid inlet 142 can define a plurality of openings having very small diameters of uniform size. The diameter of the openings can affect the droplet size. Thus, controlling the opening diameters can control the size of the droplets entering the mixing zone 120.

The backpressure regulator 132 is preferably a 26-1700 type regulator, which is commercially available from Tescom, USA (Elk River, Minn.) and is interchangeable with other like valves that are known to those of ordinary skill in the art.

The mixer assembly 148 includes a motor 160, a shaft 162 extending from the motor 160 through the second end 116 of the vessel 110 and into the chamber 118, and a rotor 164 disposed at a distal end of the shaft 162 and located in the chamber 118. The mixing rate is controlled by the rotation speed and geometry (type and diameter) of the rotor 164 as well as the type, orientation and size of the inlets 142, 144.

Alternatively and preferably for large-scale industrial applications, the mixer assembly can be represented by external magnetic driver which is located in the close proximity to the upper end of the vessel or sidewalls and rotates coaxially with the rotor. Magnetically driven rotors advantageously do not require a shaft and corresponding seals for operation. The rotor is fixed in the position by the magnetic forces extending from the magnetic driver.

The rotor 164 can be either a cylinder with a smooth surface 166, a cylinder with a modified surface (e.g., having grooves, channels, blades, etc. provided thereon), a turbine with multiple blades, or a similar device providing high-energy mixing within the specified mixing volume and further providing the plug flow within the mixing volume. The rotor 164 preferably extends radially outward from the shaft 162 to a location spaced inwardly away from the inner surface 117 of the side wall 113.

The mixing zone 120 is the portion of the mixing chamber 118 defined as being the space between the rotor surface 166 and the vessel inner surface 117. Other than the rotor 164 and the shaft 162, the mixing zone 120 of the chamber 118 is generally unobstructed so that the solution dispensed into the chamber 118 through the liquid inlet 142 and the supercritical fluid flowing into the chamber 118 through the fluid inlet 144 can flow through the apparatus 100. If a solid cylinder rotor is used, the mixing zone 120 preferably has a width between the rotor surface 166 and the vessel inner surface 117 of less than about 1000 micrometers or microns, and more preferably in a range of from about 150 to about 200 micrometers. In alternative embodiments of the invention that have, for example, turbine blades or the like, the width is measured from the surface of the blade that is nearest the inner surface 117.

With reference to the length of the rotor 164, the rotor 164 preferably extends axially along a substantial portion of the inner surface 117, longer than the dimensions of the liquid inlet port 142, and more preferably extends axially along a portion of the inner surface 117 that is more than two diameters of the chamber liquid inlet port.

The rotor surface 166 preferably has sufficient surface area and is in such close proximity to the inner surface 117 to generate a combination of shear mixing, turbulent mixing and centrifugal mixing. In shear mixing, mixing proceeds by the shear forces generated in the thin layer between the rotor and the wall. Turbulent mixing is caused by the high-speed rotation creating intense mixing of a turbulent character between the solution and the supercritical fluid. In centrifugal mixing, the solution is thrown outward as it impacts the rotor surface and is intensely mixed with the incoming supercritical fluid in the mixing zone.

Preferably, a controller (not shown) communicates with and controls the supercritical fluid pump 124, the solution feed pump 126, the relief valve 130, the backpressure regulator 132, the thermostat 134, and the mixer assembly 148. Suitable controllers are well known in the art and are interchangeable therewith.

The solution dispensed into the mixing zone through the liquid inlet 142 by the solution feed pump 126 comprises a solute dissolved in a solvent. The solvent must be at least partially soluble in the supercritical fluid used in the process. Preferred solvents or oils include alcohols, toluene, dimethyl sulfoxide (DMSO), dimethyl formamide (DMF), tetra hydrofuran (THF), acetone, water, ethyl acetate, methylene chloride, and other organic or inorganic solvents.

The solute can be any material that is soluble or dispersible in the solvent. Preferred solute materials include, for example, medicinal agents, biologically active materials, sugars, pigments, toxins, insecticides, viral materials, diagnostic aids, agricultural chemicals, nutritional materials, proteins, alkyloids, alkaloids, peptides, animal and/or plant extracts, dyes, explosives, paints, polymer precursors, cosmetics, antigens, enzymes, catalysts, nucleic acids, and combinations thereof.

It will be appreciated that the solution dispensed into the mixing zone can comprise a plurality of solutes dissolved and/or dispersed in a plurality of solvents. When multiple solutes are present in the solution, the resultant particles will contain all of the solute constituents. If micro-encapsulates, microspheres, coated particles or co-precipitated particles are desired, a carrier or matrix material can be dissolved in the same solution. Preferred matrix material includes polymer, filler, disintegrant, binder, solubilizer, excipient, and combinations thereof. In particular, the matrix material can be, for example, polysaccharides, polyesters, polyethers, polyanhydrides, polyglycolides (PLGA), polylactic acid (PLA), polycaprolactone (PCL), polyethylene glycol (PEG), and polypeptides.

In alternative methods, some of which are described hereinbelow, the morphological relation of the solute constituents to each other post-particulation can be controlled. For example, a first constituent can form a particle core, while a second constituent can form a particle shell or coating overlaying the surface of the core. This control can be achieved, for example, by using materials having differing solubilities. The less soluble material can reach supersaturation first so as to precipitate and form a seed (or core) for the relatively more soluble material.

If the solution is an emulsion, a surfactant, homogenizer or emulsifier (hereinafter “surfactant”) can be added to stabilize the emulsion. These surfactants include biodegradable and pharmaceutically accepted surfactants. However, emulsion systems can also be formed with very little or no surfactant to achieve short-term emulsion stability required for the duration of a supercritical fluid process according to the invention. Thus, a variety of emulsion types are suitable for use with the present invention. For example, oil-in-water (o/w), water-in-oil (w/o), water-in-oil-in-water (w/o/w), and oil-in-oil (o/o) are suitable emulsion types for use with the present invention. Preferred surfactants include non-ionic, anionic and cationic surfactants. Preferred emulsifiers include, for example, biodegradable surfactants such as Tween, poly(vinyl pyrrolidone), polyglycerol, polyricinoleate, poly(vinyl alcohol), and block copolymers.

The supercritical fluid is preferably supercritical carbon dioxide (“CO₂”). Carbon dioxide is supercritical when certain environmental parameters are met, for example, when the carbon dioxide is above the temperature 304.2 Kelvin (K) and above the pressure 7.38 megaPascal (MPa). Suitable alternative supercritical fluids include water, nitrous oxide, dimethylether, straight chain or branched C₁-C₆ alkanes, alkenes, alcohols, and combinations thereof. Preferable alkanes and alcohols include ethane, ethanol, propane, propanol, butane, butanol, isopropane, isopropanol, and the like. The supercritical fluid is matched to the solute and solution being used in the process. The solute is generally insoluble in the supercritical fluid, while the solvent is generally soluble in the supercritical fluid.

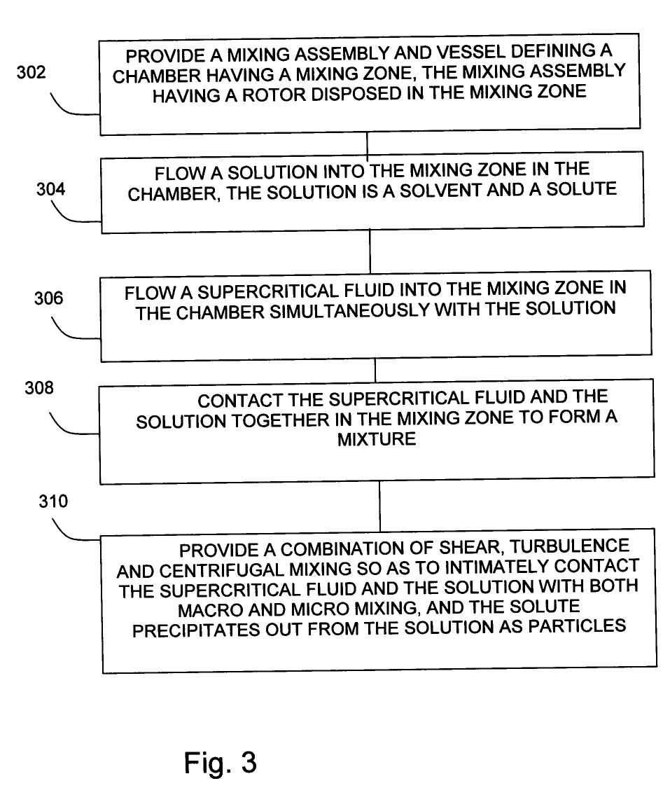

During operation and with reference to FIG. 3, which is a block diagram of the method according to the invention, the apparatus 100 is assembled such that the mixing assembly 148 has the rotor 164 in the mixing zone 120 in the chamber 118 (step 302). The thermostat 134 controls the heaters to maintain the temperature of the vessel 110 at a predetermined temperature. The solution feed pump 126 supplies liquid solution through the inlet port 142 and into the chamber 118 (step 304). Specifically, the fluid inlet port 142 directs the solution into the mixing zone 120. The supercritical fluid pump 124 supplies supercritical fluid through the fluid inlet 144 and into the chamber 118 (step 306). Preferably, the supercritical fluid inlet 144 directs the supercritical fluid through the frit and into the mixing zone 120. The solution and the supercritical fluid contact each other in the mixing zone 120 (step 308).

The mixing assembly 148 is engaged so that the motor 160 rotates the rotor 164. The spinning rotor 164 mixes the supercritical fluid and solution entering the mixing zone 120 on both a macro-scale (physical mixing) and a micro-scale. Micro-scale mixing is defined as local mixing with a characteristic dimension of several microns or less.

Preferably, the rotor 164 mixes in both the tangential and radial direction of the rotation due to the high shear forces, centrifugal forces and turbulence created between the spinning rotor surface 166 and the vessel wall inner surface 117. The plug flow propagates axially downward in the mixing zone 120 in the direction indicated by the directional arrow labeled FLOW. The preferred rotation speed is in the range of from about 100 to about 20,000 revolutions per minute (RPM), and more preferably in the range of from about 1,000 to about 10,000 rpm.

In response to the micro-scale mixing in the mixing zone 120, the solvent is dissolved from the solution into the supercritical fluid, thus forming a mixture of solvent and supercritical fluid. The loss of the solvent from the solution causes supersaturation of the solution, which results in precipitation of the solute as small particles. If the solution is an emulsion or has a liquid that is not soluble in the supercritical fluid, the solute precipitates as particles that are suspended in a liquid (i.e., a liquid suspension).

Mixing of the supercritical fluid and the liquid solution preferably occurs in the entire cross-section of the flow, which leads to uniform particle precipitation. A substantial portion of the precipitation occurs within the mixing zone 120. As discussed hereinabove, the configuration of the vessel and/or the mixer, and the direction or orientation of the flow of supercritical fluid into the chamber, creates a plug flow in the mixing zone. The plug flows moves the particles from the mixing zone as they are precipitated or formed. Because of the high intensity homogeneous mixing and plug flow configuration, the particle uniformity is enhanced and production of composite particles facilitated.

The particles or liquid particle suspension collects in the bottom of the chamber 118. The supercritical fluid/solvent mixture is removed from the chamber 118 by the backpressure regulator 132 through the filter 152. The filter 152 separates the solute particles 146 from the supercritical fluid/solvent mixture as it exits the vessel 110. An additional relief valve, preferably with a pressure filter (not shown), can remove the suspension, if desired. In alternative embodiments, the solid particles can be separated from the suspending medium via a cyclone-type separator.

The precipitated particles are preferably cleaned of any residual solvent inside the chamber 118. This can be accomplished by stopping the flow of solution into the vessel while continuing the flow of supercritical fluid through the vessel 110. The continued flow of supercritical fluid is maintained for a time sufficient to purge the residual solvent present in the supercritical fluid phase inside the vessel. In other words, solvent free supercritical fluid is circulated through the vessel 110 in order to remove the solvent-bearing supercritical fluid. In this manner, particles are produced having desirably low residual solvent levels. After cleaning, the vessel 110 is depressurized to obtain the solvent free particles.

The resultant particles 146 can include crystalline, semi-crystalline and amorphous powders of small-molecules, powders of polymeric and biological molecules, specifically but not limited to biologically-active medicinal substances, therapeutic proteins and peptides intended for different drug delivery applications. Examples of composite particles nano-spheres and micro-spheres, and nano-capsules and microcapsules. The spheres and capsules include, for example, a combination of therapeutic or biologically active agents coated or incorporated into a carrier polymer or excipient. The spheres and capsules are generally suitable for controlled, sustained or modified drug release, taste masking or modifying, and drug solubilization.

It is noted that the solution supplied to the chamber 118 for particle production is generally a solute dissolved in a solvent, however, the solution supplied to the chamber 118 can be also an emulsion or a suspension of particles. The configuration of rotor and vessel can be selected so as to affect the morphology of the particles formed by the process according to the invention. If a suspension is supplied, the suspension's carrier liquid can be a solution. Thus, particles forming from the carrier liquid can use the suspended particles as seeds, thus forming composite particle.

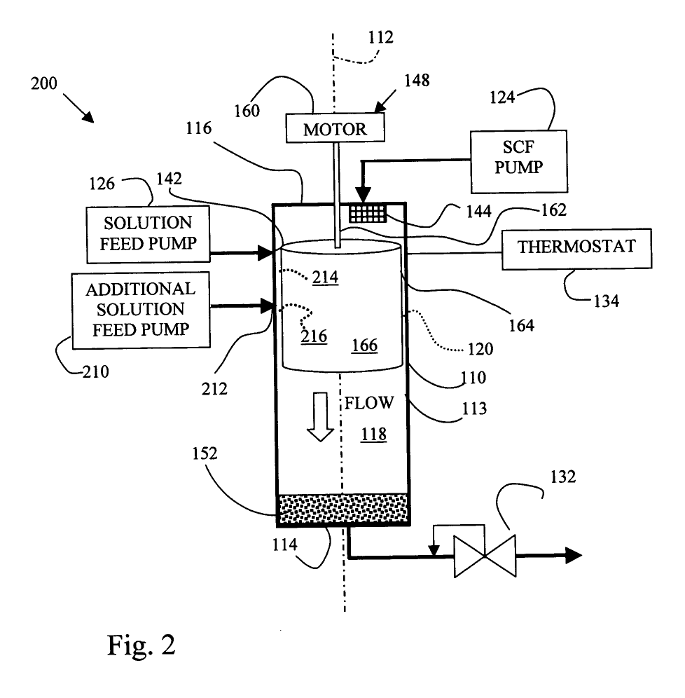

An apparatus 200 comprising a second embodiment of the invention is schematically shown in FIG. 2. The apparatus 200 has many parts that are substantially the same as corresponding parts of the apparatus 100 shown in FIG. 1. This is indicated by the use of the same reference numbers in FIGS. 1 and 2. The apparatus 200 differs from the apparatus 100 in that there is at least one additional liquid feed source 210 communicating with an additional liquid solution inlet 212 so as to direct a second solution into the chamber 118. Alternatively, multiple fluid streams can be co-introduced into the chamber 118, for example via a co-axial inlet arrangement. It will be appreciated that two or more liquid feed sources 210 and solution inlets 212 can be provided in the apparatus 200, as needed.

The solution inlet 142 directs solution into a first portion 214 of the mixing zone 120. The additional liquid solution inlet 212 is oriented so as to direct the second solution into a differing second portion 216 of the mixing zone 120 relative to the solution inlet 142. Preferably, the second portion 216 of the second mixing zone 120 is spaced axially below the first mixing zone portion 214, to which the first solution inlet 142 directs the first solution and/or rotated by a fixed angle from the first solution inlet. The position of the second inlet depends on the character and rate of precipitation of solutes in the first and second liquid streams and can be optimized empirically or on the basis of known precipitation constants such as nucleation and growth time constants.

During operation of the apparatus 200, the mixing assembly 148 is engaged to rotate the rotor 164, and the thermostat 134 controls the temperature of the vessel 110 to a predetermined temperature. The supercritical fluid pump 124 supplies supercritical fluid to the mixing zone 120.

The solution feed pump 126 supplies the first solution through the first solution inlet 142 to the first portion 214 of the mixing zone 120. Simultaneously, the second fluid pump 210 supplies the second solution through the second solution inlet 212 to the second portion 216 of the mixing zone 120.

As described hereinabove, the first solution is intimately and intensely micro-mixed with the supercritical fluid in the first portion 214 of the mixing zone 120. The supercritical fluid strips or dissolves the solvent from the first solution. The loss of solvent causes supersaturation of the first solution and solute precipitates out of the first solution as particles.

The precipitated particles, or first particles, formed in the first mixing zone portion 214, flow in the direction indicated by the directional arrow labeled FLOW into the second mixing zone 216. The solute from the second solution precipitates from the second solution as solvent from the second solution is stripped or dissolved into the supercritical fluid. The precipitate of the second solute coats or encapsulates the first particles. Preferably, the first particles act as seeds for the precipitation of the second solute.

For example, a drug is dissolved in the first solution and a polymer or lipid is dissolved in the second solution. The drug particles precipitate in the first mixing zone, and the drug particles flow into the second mixing zone where they act as seeds. The drug particles are coated or encapsulated by the polymeric or the lipid substance that is the second solute as the second solute precipitates out of solution onto the drug particles. Alternatively, variations of this method can be accomplished by utilizing solvents having differing solubilities in the supercritical fluid.

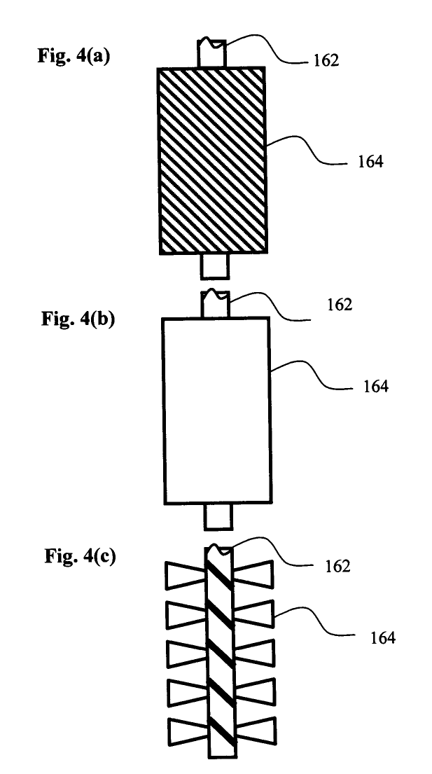

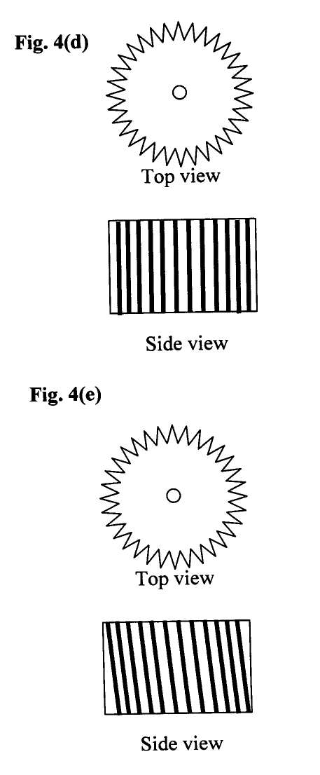

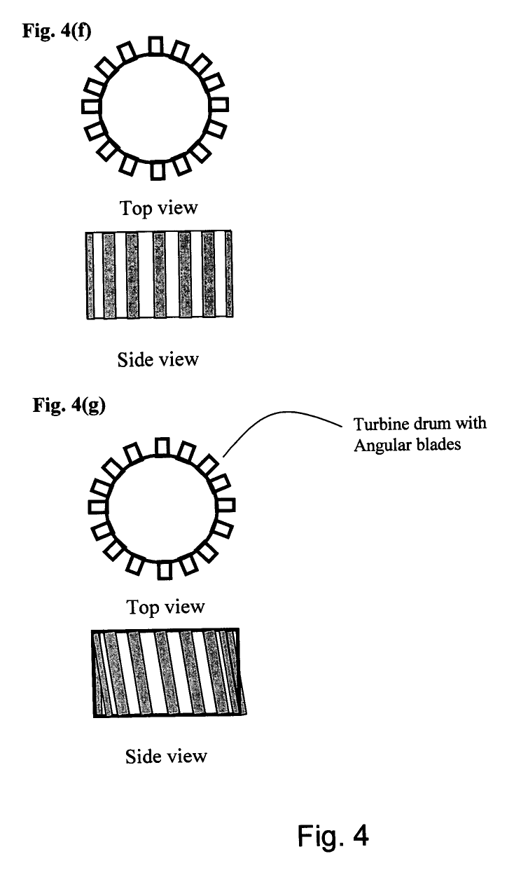

Suitable rotor surfaces are schematically shown in FIGS. 4(a)-(6). FIG. 4(a) shows a shear-type mixing-drum having grooves. FIG. 4(b) shows a smooth rotating drum. FIG. 4(c) shows a turbine mixer. FIGS. 4(d) and (e) show top and side views of a preferred turbine mixer with straight and angular sharp edged blades, respectively. FIGS. 4(f) and (g) show the top and the side views of a preferred turbine mixer with straight and angular squared blades, respectively. The rotors used in the invention are preferably made of Teflon (PTFE) or stainless steel materials.

The following examples are intended only to illustrate the invention and should not be construed as imposing limitations upon the claims. Unless specified otherwise, all chemicals used in the examples can be obtained from Sigma Aldrich, Inc. (St. Louis, Mo.) and/or Fisher Scientific International, Inc. (Hanover Park, Ill.).

### EXAMPLE 1

The precipitation experiments were carried out using rotors of different diameters and surface structure in order to determine the effect of rotor diameter and surface structure on the size and morphology of the precipitated particles.

The rotors used in Example 1 were as shown in FIG. 4, namely: (i) a Teflon smooth drum (see FIG. 4b) with a diameter of 31.5 mm (or 0.215 mm thickness of the gap between the rotor surface and sidewall in the mixing chamber); (ii) a Teflon smooth drum (FIG. 4b) with a diameter of 27.5 mm (or 2.215 mm gap); and (iii) a stainless steel propeller turbine (FIG. 4c) with a diameter of 27.5 mm with 12 blades, 5 mm long (radial length) and pitch about 15° from the vertical.

Procedure:

Acetaminophen (APAP, paracetamol) was dissolved in ethanol at 2% weight/volume to form a solution. Supercritical carbon dioxide was used as the supercritical fluid. The flow rate of CO₂ was set at 100 g/min. The liquid CO₂ became supercritical after entering the heated thermostat controlled vessel 110.

The flow rate of solution was set at 2 milliliters/minute (ml/min). The working pressure was 20 MPa, temperature 313K. An apparatus substantially the same shown in FIG. 1 was used. The rotational speed of the rotor was maintained constant at 4000 rpm for all trials.

Once the supercritical fluid flow was commenced and the rotor had achieved the proper rotation speed, the solution was injected into the vessel 100 and into contact with the rotating drum surface. After the precipitation and purging process were completed, the chamber was depressurized and the APAP particles were collected.

Analysis:

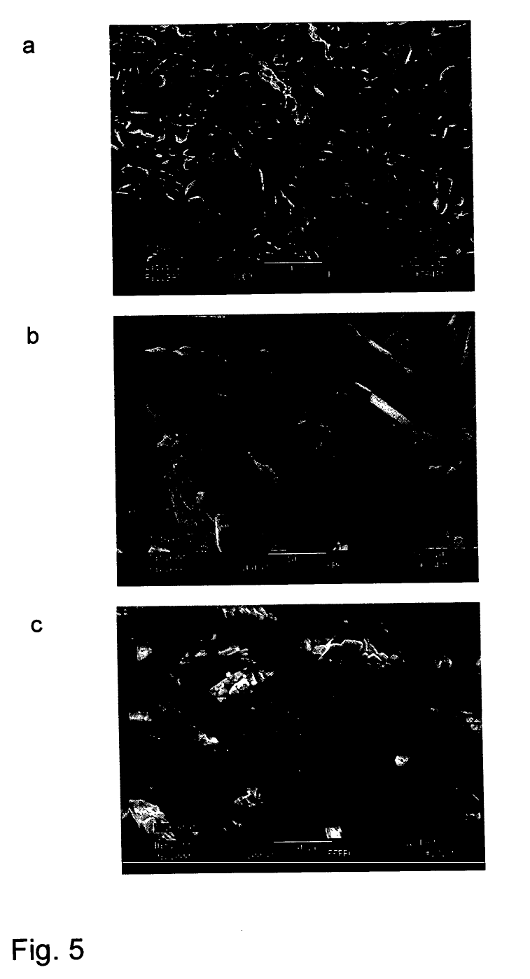

The mean volume size of the particles was determined using a laser light scattering size analyzer (Horiba LA-910) and cross-correlated with image analysis using scanning electron microscopy (SEM). The micrographs are shown in FIGS. 5(a)-(c), where: FIG. 5(a) shows particles having a mean particle diameter of 4.46 μm produced using the Teflon smooth drum rotor having a diameter of 31.5 mm; FIG. 5(b) shows particles having a mean particle diameter of 14.5 μm produced using the Teflon smooth drum rotor having a diameter of 27.5 mm; and FIG. 5(c) shows particles having a mean particle diameter of 8.7 μm produced using the stainless steel propeller turbine with a diameter 27.5 mm. The results show that there is a significant decrease in particle size as the rotor gets closer to the side wall of the mixing chamber. The photographs shows that particles also become less uniform and of acicular shape with increasing the mixing gap between the rotor and the sidewalls of the mixing chamber. A comparison between the photographs in FIG. 5 also shows that propeller rotor provides better mixing than the smooth drum of the same diameter, however is less effective than the smooth rotor with the reduced mixing gap. Therefore decreasing the gap between the vessel surface and the drum inner surface increases the intensity of mixing, leading to smaller and more uniform particles. This experiment also show that the shear mixing is more important than mixing introduced by the centrifugal forces because the linear velocity of the drum did not decrease significantly (by about 10%) whereas the gap changed by the factor of 10.

### EXAMPLE 2

The following example illustrates the influence of rotation speed on particle size and morphology for a smooth rotor.

Production:

An apparatus substantially the same as the apparatus used in FIG. 1 was used for particle precipitation. The Teflon smooth drum (see FIG. 4b) with a diameter of 31.5 mm was used at two rotation speeds, namely: (i) 300 RPM; (ii) 3,500 RPM. The characteristic dimensionless number is the Reynolds number: Re=ud/v, where ‘v’=1.25×10⁻⁷ m²/s is the kinematic viscosity of CO₂ at given pressure and temperature, ‘u’ is the linear velocity of the drum, and ‘d’=0.215 mm is the gap dimension between the rotating drum and the internal reactor wall. The corresponding Re was calculated to be 850 and 9,930.

Analysis:

For the low rotation speed 850, the particles examined with scanning electron microscope (SEM) had formed having irregular shapes, or were extensively aggregated by bridging. The aggregated and irregular particles had a mean size of above 10 micrometers (μm). The particles obtained at the high rotation speed (Re=9,930) had a more uniform morphology and a mean diameter of about 5 μm, which is similar to those shown in FIG. 5(a). Accordingly, the increase of the rotation speed leads to relatively decreased particle size and improved particle morphology.

### EXAMPLE 3

The following example illustrates precipitation of APAP particles using a turbine rotor as shown in FIG. 4(f). The precipitation experiments were carried out at different drum speeds in order to determine the effect of drum speed on the size of the precipitated particles.

Procedure:

An apparatus substantially the same as used in Examples 1 and 2. APAP was dissolved in ethanol at 2% weight/volume to form a solution. Supercritical carbon dioxide was used as the supercritical fluid. The flow rate of the supercritical fluid was set at 100 g/min. The rotor used was a Teflon turbine rotor, as shown in FIG. 4(f), having a diameter d=31.5 millimeters (mm). The working pressure was maintained constant at 15 MPa and temperature at 323 K. The rotor speed was maintained at the predetermined values listed in Table 1. The characteristic Reynolds numbers for each rotational speed are also listed in Table 1 below:

TABLE 1

| Rotational | Linear | Reynolds | Vol. Avg. | SD |
|---|---|---|---|---|
| Speed (rpm) | Speed (m/s) | Number | μm | μm |
| 100 | 0.16 | 284 | 21 | 8 |
| 560 | 0.92 | 1587 | 6.34 | 2.8 |
| 1000 | 1.65 | 2835 | 7.93 | 2.47 |
| 2000 | 3.30 | 5670 | 5.55 | 2.55 |
| 4000 | 6.56 | 11341 | 4.54 | 2.24 |
| 7000 | 11.5 | 19848 | 4.1 | 2 |

The solution was injected into the vessel into the rotating drum surface using a 150-micron solution inlet. The flow rate of solution was set at 2 milliliters/minute (ml/min).

Analysis:

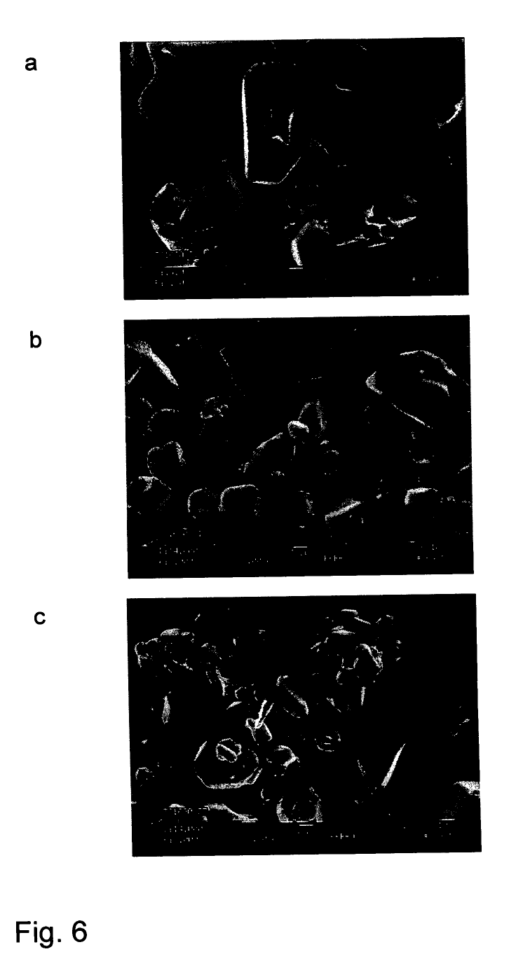

The APAP was precipitated in the form of prismatic crystals. The mean volume size of the particles was determined using laser light scattering size analyzer (Horiba LA-910) and cross-correlated with SEM imaging. The mean sizes of particles, obtained from experiments carried out at the different rotational velocities, have been listed in Table 1. FIGS. 6(a)-(c) show SEM micrographs of particles obtained from experiments carried out at the different rotational velocities, where FIG. 6(a)=560 RPM; FIG. 6(b)=4000 RPM; and FIG. 6(c)=7000 RPM.

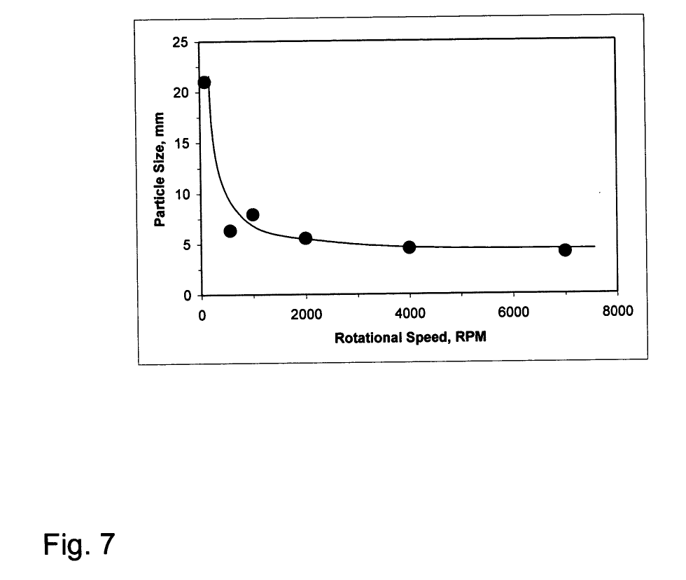

FIG. 7 is a graph illustrating the relationship between particles size and the rotational speed. It is clearly shown that increasing rotational speeds results in smaller and more uniform particles. In addition, comparison of the particles formed in Example 3 (FIGS. 6(a)-(c) with the particles formed in Example 2 (FIGS. 5(a)-(c), indicate that the turbine rotor of type shown in FIG. 4(f) is a more efficient mixing device, which combines intensive turbulent and shear mixing thus allowing for uniform mixing in the whole mixing area of the mixing chamber.

### COMPARATIVE EXAMPLE 4

The following example illustrates precipitation of APAP particles using a standard PCA process. In other words, the solution was merely injected into the supercritical fluid without rotor mixing.

Procedure:

The apparatus, operating conditions and flow rates were substantially the same as in Example 3, except that no rotating rotor was used. The solution was injected at the top end of the precipitation vessel 100 using a 150-micron nozzle.

Analysis:

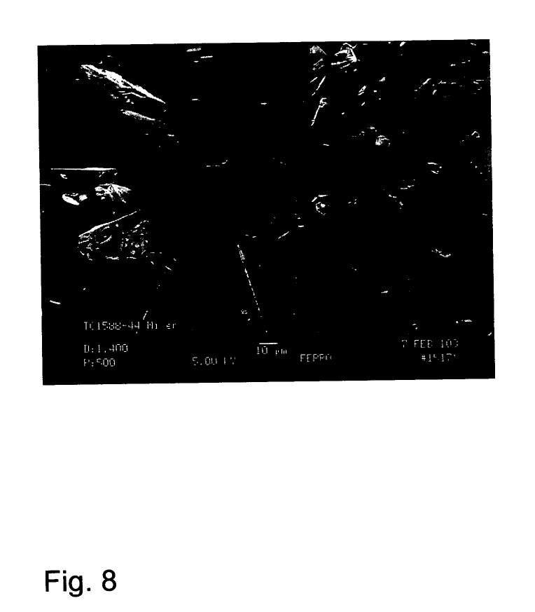

FIG. 8 shows an SEM of the APAP precipitated in Example 4. The particles were in the form of long hollow needles, with needle length varying between 10 and 200 μm. The mean size was determined to be about 50 μm. In some respects, the morphology of the particles obtained in Example 4 is similar to the morphology of the particles obtained at low RE using a smooth rotor in Example 2. This suggests that the particles were obtained at relatively low mixing rates and low supersaturation, which resulted in a wide particle size distribution and needle-like morphology.

### EXAMPLE 5

The following example illustrates precipitation of Griseofulvin particles using the turbine mixing drum as shown in FIG. 4(f). A comparative experiment was conducted without the drum in order to determine in the effect of increased mixing by the drum on the size of the Griseofulvin particles.

Procedure:

The Griseofulvin particle precipitation experiments were carried out in the same manner as that of Acetaminophen described in Example 1. Griseofulvin was dissolved in ethanol at 2% weight/volume to form a solution. Supercritical carbon dioxide was used as the supercritical fluid. A Teflon turbine rotor as shown in FIG. 4(f) having a diameter of 31.4 mm was used to carry out the experiments. The pressure and temperature during the experiment was maintained constant at 323 K and 15 Mpa, respectively. The rotational speed of the rotor was maintained constant at 4000 rpm for all trials in which a rotor was used. The solution and CO₂ flow rate was 2 ml/min and 100 g/min, respectively. The solution was injected onto the drum using a 150 μm solution port. Griseofulvin precipitation experiments were also carried out under the same conditions without the Teflon turbine drum or with no enhanced mixing.

Analysis:

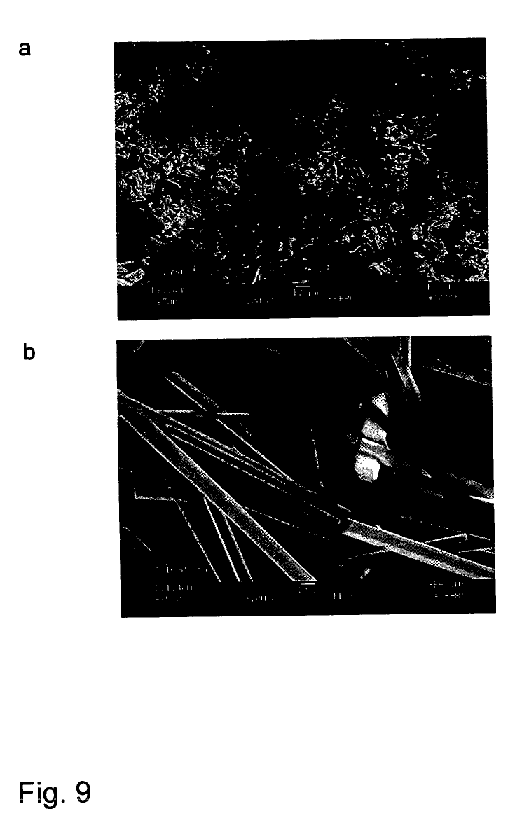

The precipitated Griseofulvin particles were obtained in the form of fine orthorhombic crystals as shown in FIG. 9a, under high mixing conditions. The mean volume size and standard deviation of the particles as determined light scattering size analyzer (Horiba LA-910) for experiments carried out at 4000 rpm was 6.1 μm (5.9 μm). Griseofulvin particles obtained from experiments carried out without the mixing drum were in the form of large needle shaped crystals several millimeters in size as in FIG. 9b. The SEM micrographs clearly illustrate a very significant the change in the size morphology of the particles with increased mixing caused by the turbine rotor.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method of producing particles comprising the steps of:
providing a supercritical fluid;
providing a first solution, the first solution comprising a first solute dissolved or dispersed in a first solvent that is at least partially soluble in the supercritical fluid;
flowing the supercritical fluid through a chamber having a rotating rotor disposed therein;
dispensing the first solution into a mixing zone within the chamber while the supercritical fluid is flowing through the chamber, the mixing zone being defined as a space between an inner wall of the chamber and an adjacent surface of the rotating rotor; and
collecting precipitated particles of the first solute from a mixture comprising the supercritical fluid and the first solvent.

2. The method of producing particles according to claim 1 wherein the rotating rotor intimately mixes the first solution and the supercritical fluid together via shear mixing, turbulent mixing and/or centrifugal mixing.

3. The method of producing particles according to claim 1 wherein the first solution is dispensed into the mixing zone through one or a plurality of ports provided in the inner wall of the chamber.

4. The method of producing particles according to claim 1 wherein the rotating rotor is a smooth drum, a grooved drum, a propeller rotor or a turbine rotor.

5. The method of producing particles according to claim 1 wherein the rotor rotates within the chamber at a speed of from about 100 to about 20,000 RPM when the solution is being dispensed into the mixing zone.

6. The method of producing particles according to claim 1 wherein the inner wall of the chamber is spaced apart from the surface of the rotating rotor a distance of from about 0.1 mm to about 2.5 mm.

7. The method of producing particles according to claim 1 further comprising the steps of:
providing a second solution, the second solution comprising a second solute dissolved or dispersed in a second solvent that is at least partially soluble in the supercritical fluid; and
dispensing the second solution into the mixing zone at the same time the first solution is being dispensed into the mixing zone.

8. The method of producing particles according to claim 7 wherein the first solution is dispensed into the mixing chamber through a first solution port and the second solution is dispensed into the mixing chamber through a second solution port.

9. The method or producing particles according to claim 8 wherein the first solution port and the second solution port are coaxial.

10. The method of producing particles according to claim 8 wherein the first solution port and the second solution port are formed in the inner wall of the chamber at different locations within the mixing zone.

11. The method according to claim 7 wherein the first solvent and the second solvent are the same.

12. The method according to claim 1 wherein the first solute is selected from the group consisting of biologically active materials, medicinal agents, sugars, pigments, toxins, insecticides, viral materials, diagnostic aids, agricultural chemicals, nutritional materials, proteins, alkyloids, alkaloids, peptides, animal and/or plant extracts, dyes, explosives, paints, polymer precursors, cosmetics, antigens, enzymes, catalysts, nucleic acids, and combinations thereof.

13. The method according to claim 1 wherein the supercritical fluid is carbon dioxide.

14. The method according to claim 1 wherein the first solution comprises an emulsion.

15. The method according to claim 1 wherein the first solution comprises a suspension of the first solute in the form of solid phase particles dispersed in the first solvent.

16. The method according to claim 15 wherein a polymer, lipid and/or excipient is dissolved in the first solvent, and the precipitated particles collected in the collecting step comprise have a core comprising the first solute and a shell comprising the polymer, lipid and/or excipient.

17. The method according to claim 1 wherein the particles collected in the collecting step are substantially uniform and have an average diameter of less than about 5 μm.

18. The method according to claim 1 further comprising the step of: adjusting the rotational speed of the rotor, the size of the space between the inner surface of the chamber and the adjacent surface of the rotor, and/or the flow rate of the supercritical fluid and/or first solution into the chamber to obtain precipitated solute particles having a desired average particle size.

19. Particles formed according to the method of claim 1.

20. An apparatus for forming particles comprising:
a vessel having an inner wall that defines a chamber;
a rotatable rotor disposed within the chamber;
a mixing zone within the chamber, the mixing zone being defined as a space between the inner wall of the chamber and an adjacent surface of the rotatable rotor;
a supercritical fluid inlet for flowing a supercritical fluid into the chamber;
a solution inlet provided in the inner wall of the chamber for flowing a solution into the mixing zone, the solution comprising a solute dissolved or dispersed in a solvent; and
means for collecting particles of solute from a mixture comprising the solvent and the supercritical fluid.
